(19) United States
(12) Patent Application Publication
(10) Pub. No.: US 2016/0148545 A1
(43) Pub. Date: May 26, 2016

(54) PRODUCT CARRIER WITH INTERCHANGEABLE DISPLAY SLEEVE

(71) Applicant: Mohawk Carpet Distribution, Inc., Calhoun, GA (US)

(72) Inventors: Jacob A. Donadee, Philadelphia, PA (US); Gregg J. Hlade, West Deptford, NJ (US); Joseph Roan, Media, PA (US); Sean Edward Monahan, Audubon, NJ (US); Ivan Letinic, Manalapan, NJ (US)

(73) Assignee: ART GUILD, INC., Thorofare, NJ (US)

(21) Appl. No.: 14/600,901

(22) Filed: Jan. 20, 2015

Related U.S. Application Data
(63) Continuation-in-part of application No. 29/510,186, filed on Nov. 25, 2014.
Application No. 29/510,186 is a continuation-in-part of application No. 29/510,923, filed on Dec. 4, 2014.

(51) Int. Cl. G09F 5/00; G09F 3/20; A47F 7/16; A47F 5/00; A47F 7/00

(52) U.S. Cl. CPC G09F 5/00; A47F 5/0006; A47F 7/0042; A47F 7/163; G09F 3/201

(57) ABSTRACT

A carrier handle and a hanger arm for displaying a product, like floor covering, on a display rack. The carrier handle has a compact configuration that permits back-to-back placement on the display but still provides multiple display positions for product information.

### FIELD OF INVENTION

The invention relates generally to a handle for displaying a floor covering. More particularly, the invention relates to a handle for holding a sample and displaying product information on a sleeve mounted on the handle. Most particularly, the invention relates to a handle for holding a sample and mounting interchangeable sleeves for displaying product information.

### BACKGROUND

The display of floor covering samples requires a large amount of floor or wall space. Accordingly, it is desired to provide as much product information as possible with the sample while making the sample easy to handle and transport. One solution to the problem is to employ rack systems that display the products in either a carousel or a liner fashion. Either system allows samples to be removed and transported. While this has provided some mobility, the problems of improved handling, ease of display and increased product information remain.

### SUMMARY

The present invention provides a product carrier with an elongated carrier body for easy balanced handing. The body has upper and lower portions that provide separate functions with respect to product display and information and display rack hanging. The carrier includes means for accepting interchangeable inserts or sleeves for display products and product information.

### BRIEF DESCRIPTION OF THE DRAWING(S)

A preferred embodiment of the invention will be described with reference to the following drawing figures wherein:

FIG. 1 illustrates a carrier body according to the present invention;

FIG. 2 illustrated the assembly of an insert or sleeve to a carrier body;

FIG. 3 is an enlarged view of the circled portion in FIG. 2 illustrating the flexible stop of the present invention;

FIG. 4 illustrated the assembly of a product display panel according to the present invention;

FIG. 5 illustrated the assembly of a product sample to the insert or sleeve according to the present invention;

FIG. 6 illustrated the assembly of a product information slat to the insert or sleeve according to the present invention;

FIG. 7 illustrates two product carriers mounted on a “V” hanger arm;

FIG. 8 is an isometric view of a hanger arm according to the invention; and,

FIG. 9 is a top plan view of the hanger arm showing the reinforcement rod.

### DETAILED DESCRIPTION OF A PREFERRED EMBODIMENT

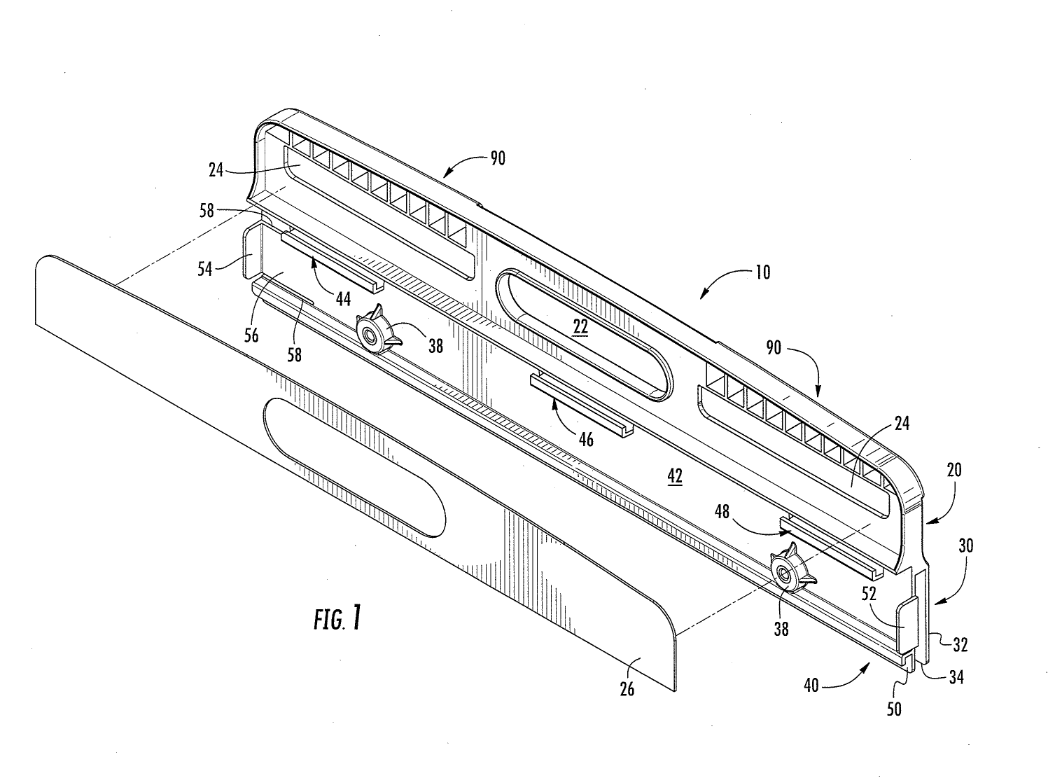

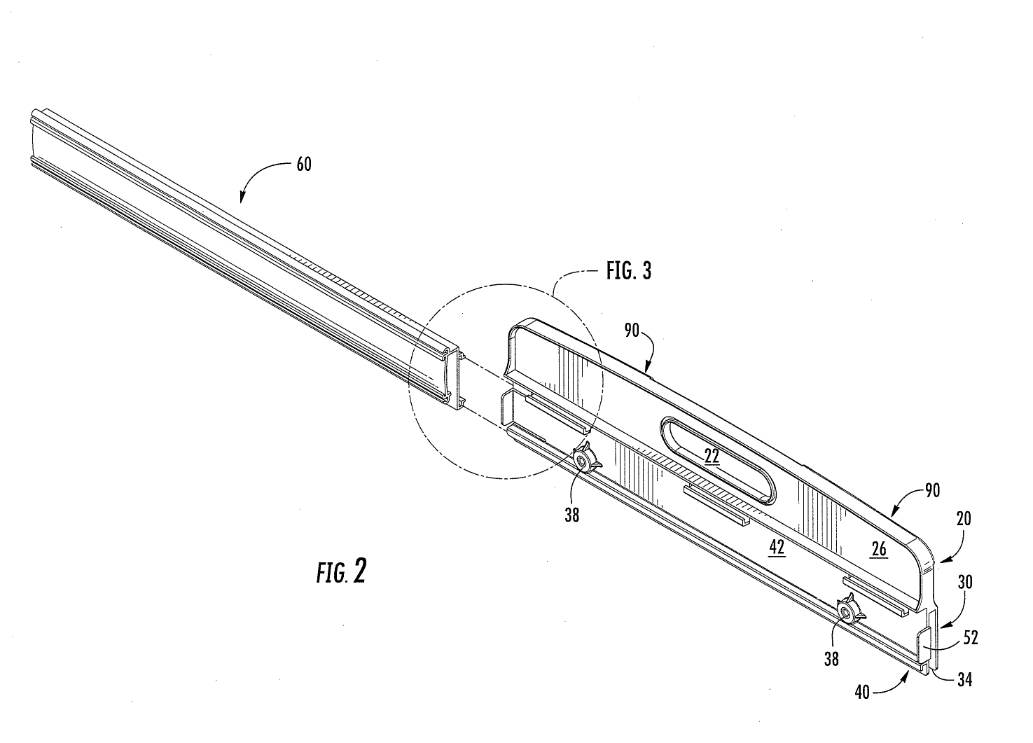

With reference to FIGS. 1, 2, 3, and 4, the carrier body 10 has an upper portion 20 and a lower portion 30, and an overall width selected to correspond to the width of the item to be displayed. With reference to FIG. 1, the facing side of the carrier body 10 is shown with the cover 26 exploded away from the upper portion 20 that defines a gripping or carrying area 22. The cover 26 is interchangeable to display a variety of information about the product or special events, such as a sale, and, when installed, closes the upper portion 20, see FIG. 2.

With reference to FIGS. 1, 2, and 3, the lower portion 30 of the facing side of the carrier body 10 has a recess 42 that includes the anchors 38 and a series of rails 44, 46, 48 and 50. The rails 44, 46, 48 and 50 are positioned to mate with complementary rails on interchangeable inserts or sleeves 60, which are discussed in more detail below.

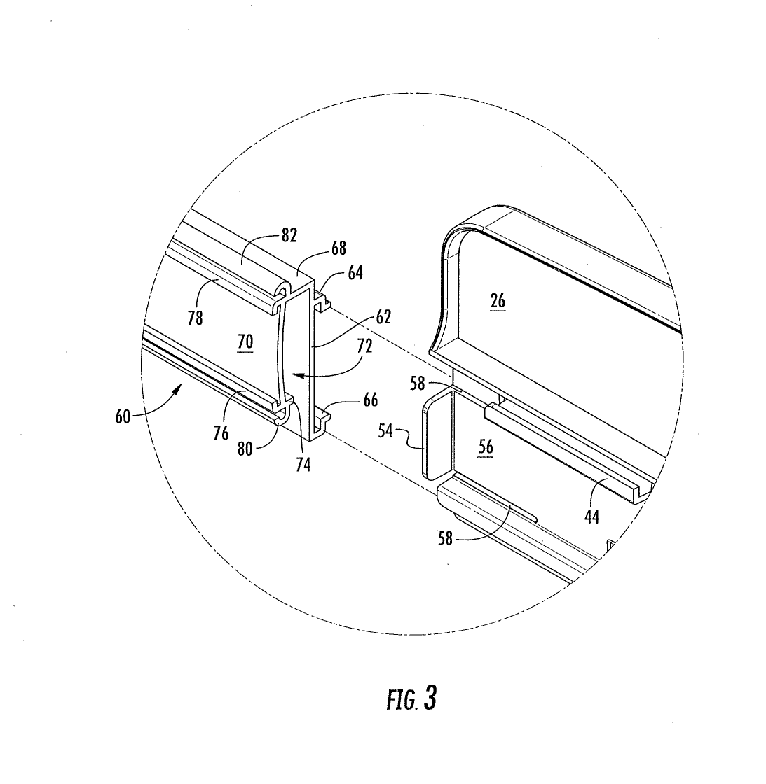

With reference to FIGS. 1 and 3, each end of the carrier body 10 has a respective stopper 52 and 54. In the preferred embodiment, stop 50 is fixed in its location, and stop 54 is connected to a flexible appendage 56. The slots 58 on either side of the appendage 56 allow it to flex. In order to connect an insert or sleeve 60 to the rails 44, 46, 48 and 50 to the bottom portion 30, the stop 54 is moved to clear the path into the bottom portion 30. This is achieved by flexing appendage 56 into the space defined by slot 34 until there is sufficient clearance to pass stop 54. After the insert or sleeve 60 clears the stop 54, appendage 56 is released and stop 54 will flex back into the original stop position. Typically, the insert or sleeve 60 has a length that is selected to be substantially equal to the space between the stops 52 and 54. Once a panel 100 is inserted into slot 34 and secured with fasteners in anchors 38, the space for flexing the appendage 56 is reduced to the point where appendage 56 cannot be flexed sufficiently and the stop 54 prevents the removal of the insert sleeve.

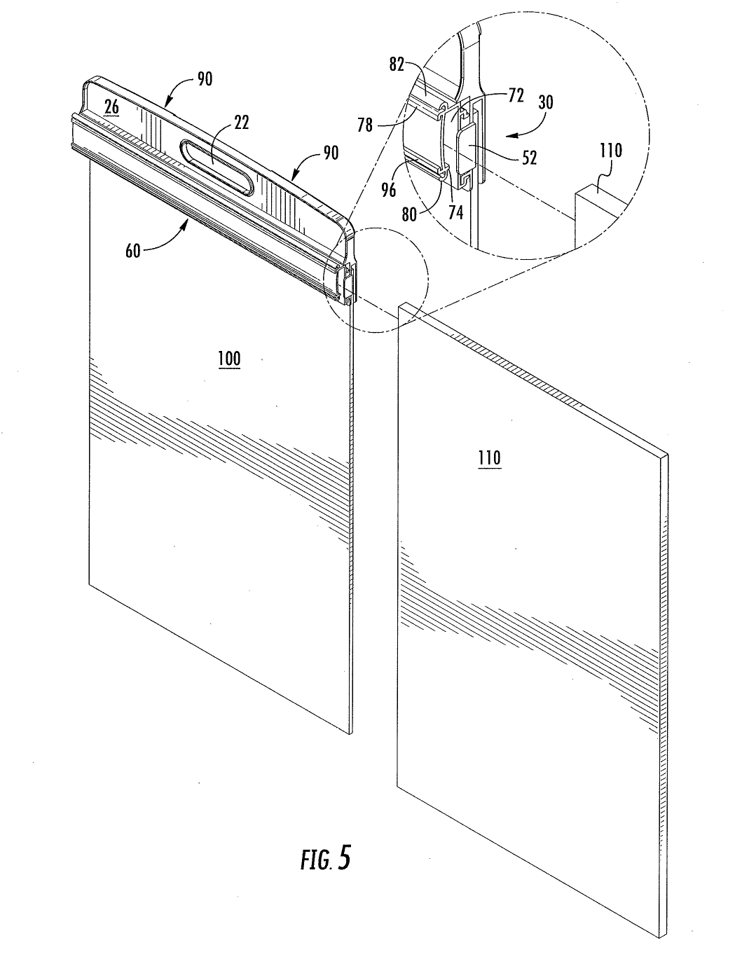

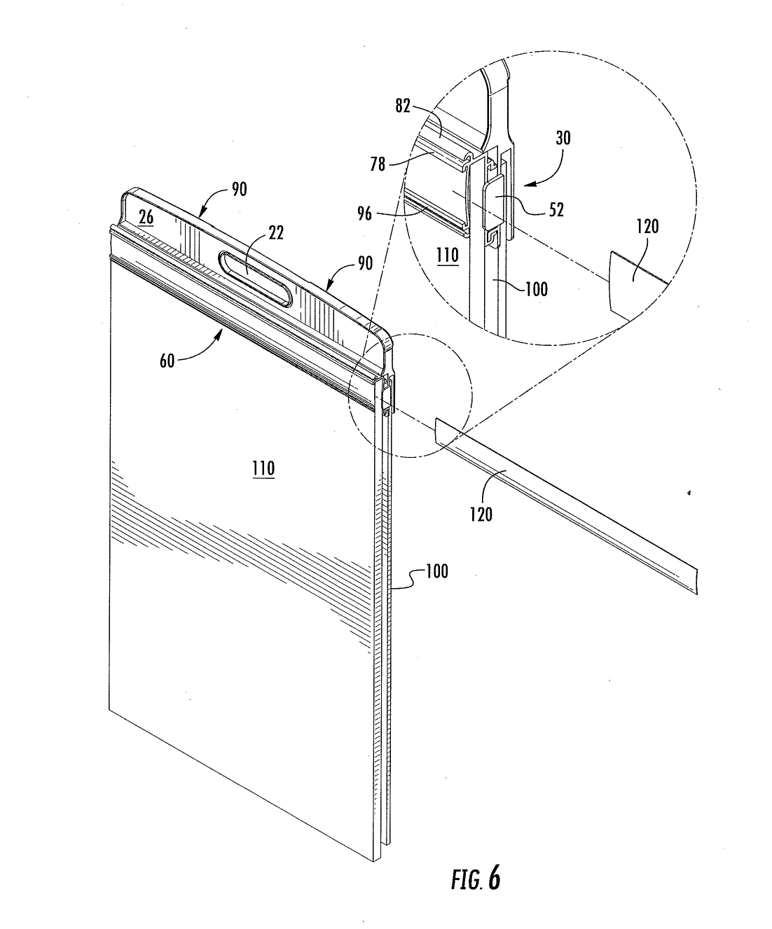

Referring to FIG. 3, a representative sleeve or insert 60 is illustrated. Interchangeable sleeves suitable for use with the present invention are disclosed in pending U.S. application Ser. No. 29/510,186, filed on Nov. 25, 2014 and assigned to the same assignee as the current application, which is incorporated herein as if fully set forth herein. The insert 60 has a back wall 62, an upper wall 68, and a front wall 70 that is spaced from back wall 62 to define a channel 72 between them. The front wall 70 includes a projection 74 that extends into the channel 72 by a sufficient distance to interfere with a product 110 inserted into channel 72, see FIGS. 5 and 6. For example, if the product 110 is carpet, the projection 74 will be of sufficient length compress the carpet pile and retain the sample in the channel 72.

The face 70 also includes opposed channels 76 and 78 that are configured to hold a product information slat for displaying a variety of information relative to the product itself, product pricing, or products that are coordinated with the product on display. The face 70 also includes a channel 80 for holding additional display information, such as a sale flag or award badge to reflect industry recognition of the product. The upper wall 68 includes a slot 82 for holding additional display information, such as a sale flag or award badge to reflect industry recognition of the product. Channels 80 and 82 can be used individually or together if desired.

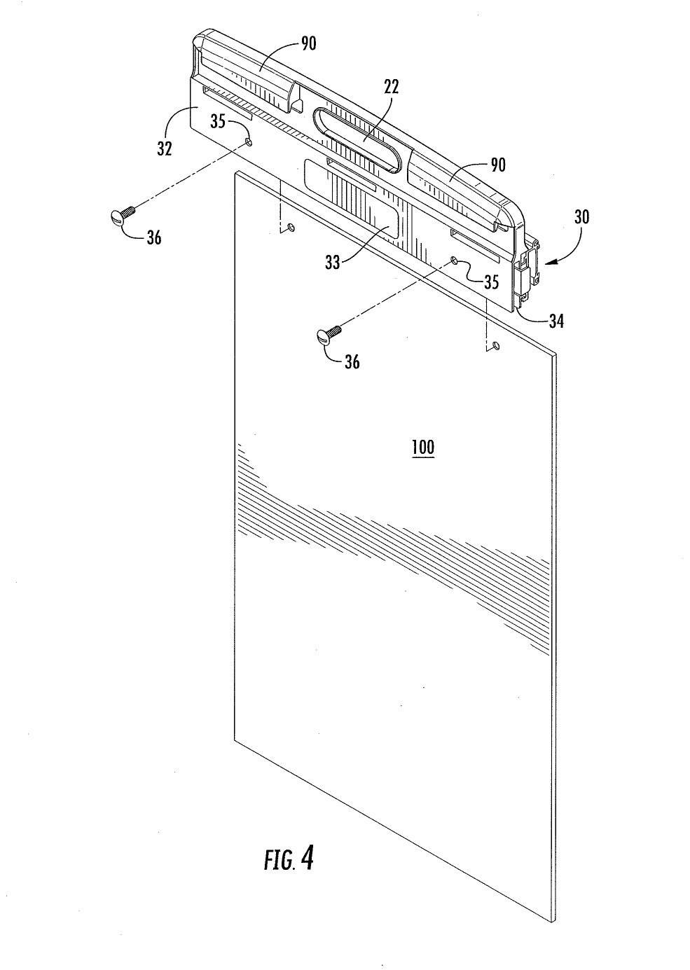

With reference to FIGS. 4, 5, and 6, the assembly of invention with product information and a product sample is explained in more detail. In FIG. 4, showing the backside of the body 30, the panel 100 is inserted in slot 34 and the fasteners 36 are secured in anchors 38 to hold the panel 100 in place and block the appendage 56 from flexing to release the stop 54. In FIG. 5, showing the face side of the body 30, the product 110 is inserted into channel 72 where it is compressed between the back wall 62 and the projection 74. In FIG. 6, the edges of information slat 120 are inserted into the channels 76 and 78 to display the selected material, which is most commonly product related information. FIG. 6 illustrates the final configuration of what is believed to be the most likely configuration.

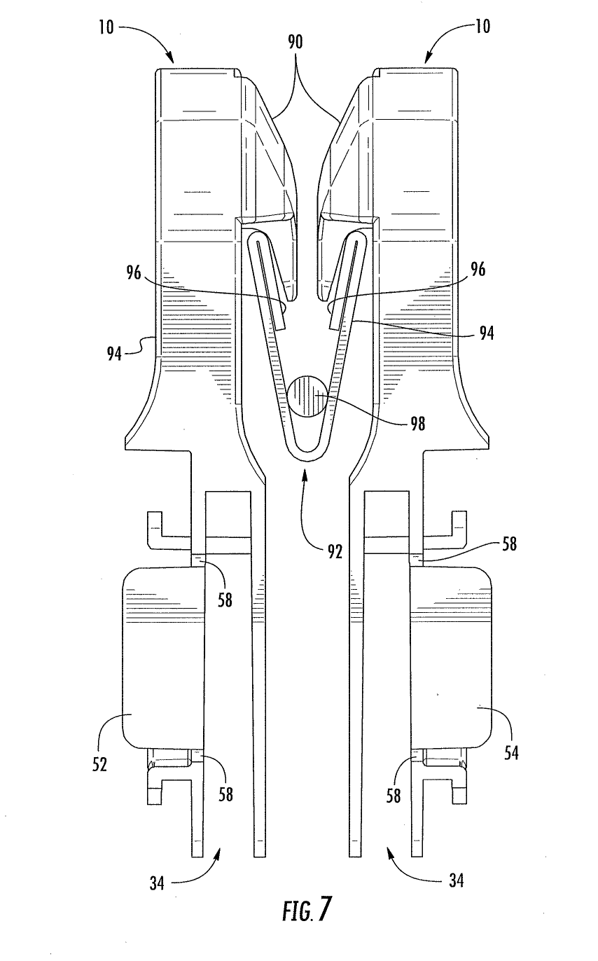

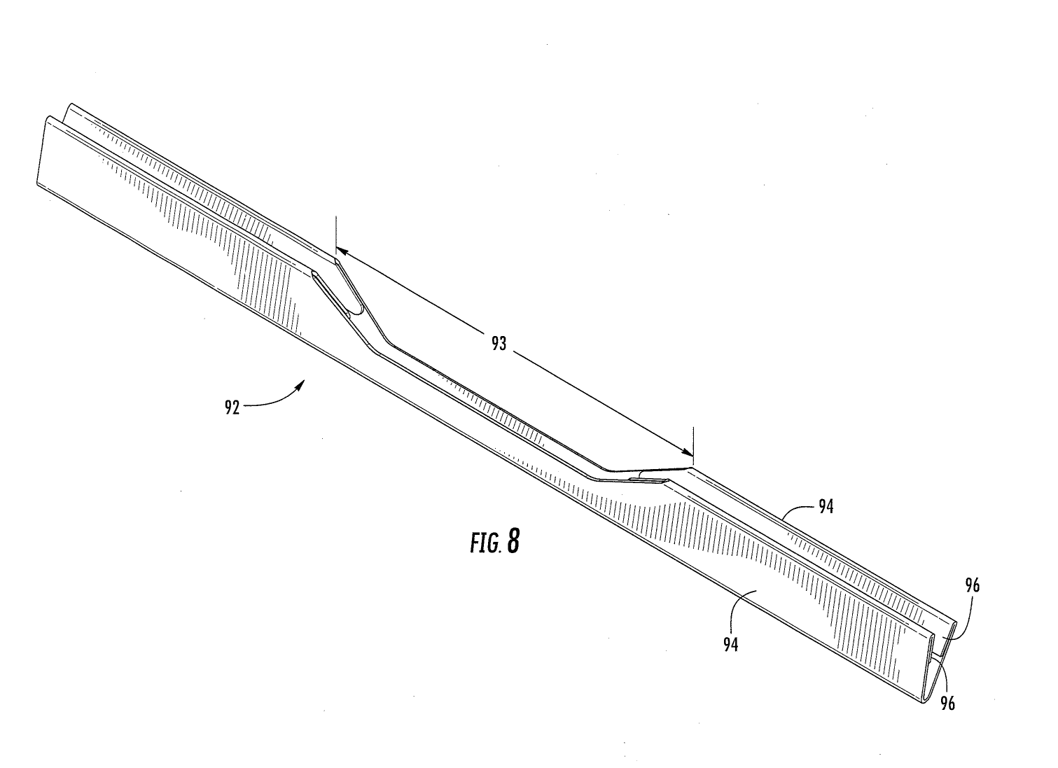

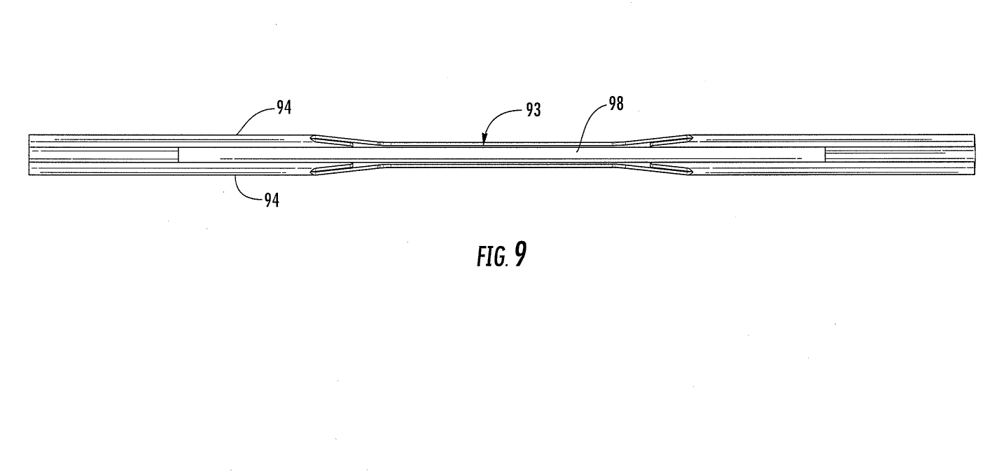

With reference to FIG. 7, it illustrates two carriers 10 that are hung back to back with the hooks 90 in the “V” shaped recess of a hanger 92 that is typically associated with a display rack. The hanger arm is preferable shaped metal that has sides 94 that flare outwardly form the center and terminate in the returns 96 that form the finished edge. With reference to FIG. 8, there is shown a recess 93 that is generally sized to be at least equal to the carrying or gripping area 22. This recess in combination with the gap between the hooks 90 provides access to the carrying or gripping area 22. With reference to FIG. 9, is a reinforcement rod 93 at the base of the “V” to improve the rigidity of the hanger 92. Preferably, the hanger is made from a metal blank that can be stamped and shaped in a forming operation. Depending upon the display system, the ends of the hanger 92 may have attachments at both ends or it may have a single attachment. If a single attachment system is used, it is preferred to close the open end with an end cap as a way of avoiding injury and adding resistance again the “V” spreading out. See FIG. 1, in U.S. application Ser. No. 29/510,923, which application is incorporated herein as if fully set forth herein.

We claim:

1. A product carrier comprising:
a carrier body having: an upper portion that defines a handle; a lower portion that defines opposed faces; and, end stops on a first selected one of the opposed faces that are spaced apart by a predetermined distance;
the first opposed face with the spaced apart end stops includes a channel for securing an insert between the end stops; and,
a second of the opposed faces defines a receiving channel for securing a display panel to the carrier.

2. The product carrier of claim 1 wherein the upper portion of the carrier body includes at least one attachment member for suspending the product carrier from a product display.

3. The product carrier of claim 1 wherein the insert includes a receiving channel for securing a product sample to the carrier.

4. The product carrier of claim 1 wherein at least one end stop is flexible.

5. The product carrier of claim 4 wherein the display panel limits flexing of the at least one flexible end stop and prevents removal of an insert positioned within the channel.

6. A hanger for holding at least one product carrier, the hanger comprised of:
a “V” shaped body having: a length selected to engage and hold a product carrier and engagement portions at each end of the body, a recess that is positioned between the engagement portions; and, a reinforcement element that is position in the “V” shaped body in the area of the recess.
